(19) United States
(12) Patent Application Publication
(10) Pub. No.: US 2022/0228549 A1
(43) Pub. Date: Jul. 21, 2022

(54) MUTUALLY SUPPORTING HYDROPOWER SYSTEMS

(71) Applicant: Chun-Huei CHEN, Puli Township (TW)

(72) Inventor: Chun-Huei CHEN, Puli Township (TW)

(21) Appl. No.: 17/153,853

(22) Filed: Jan. 20, 2021

(51) Int. Cl. F03B 7/00; F03B 3/00; F03B 11/08

(52) U.S. Cl. CPC F03B 7/00; F03B 11/08; F03B 3/00

(57) ABSTRACT

The mutually supporting hydropower systems includes a first hydropower system, a second hydropower system, and a third hydropower system. Each hydropower system includes a hydropower unit, a number of waterwheels, a number of hoist devices, and a number of motors respectively connected to the hoist devices. Each waterwheel engages a hoist device. The motors are electrically connected to a hydropower unit. The waterwheels and the hoist devices are driven by the impact of seawater which is also used by each hydropower unit to produce electricity. 40% of the power from the first hydropower system is used to drive its motors. 30% of the power from the second and third hydropower systems are also used to drive the motors of the first hydropower system. The motors are therefore sufficiently powered to discharge seawater.

### BACKGROUND OF THE INVENTION

### (a) Technical Field of the Invention

The present invention is generally related to power generation, and more particular to hydropower systems mutually supporting each other.

### (b) Description of the Prior Art

After three industrial revolutions since 1795, human has accumulated significant harm to earth's environment. Greenhouse effect caused by carbon emission, as detailed by former U.S. Vice President Gore in the documentary film “An Inconvenient Truth,” is producing immediate impact to people around the globe and many developed countries vow to switch to renewable energy sources.

Conventional electricity generation is achieved mainly through thermal power, hydropower, burning natural gas, wind power, and nuclear power. Among the renewable energy sources, large solar farm would affect ecosystem, and wind power is intermittent and unstable. Hydropower, in contrast, is the most stable and applicable one.

Conventional hydropower requires the construction of dams and large substations, leading to significant cost. Hydropower may also be influenced by drought seasons. On the other hand, seawater seems to be a more abundant and stable source that is not well utilized for power generation yet.

### SUMMARY OF THE INVENTION

A major objective of the present invention is to provide hydropower systems driven by seawater, thereby avoiding the construction huge dams, that are capable of mutually supporting each other.

The mutually supporting hydropower systems include a first hydropower system, a second hydropower system, and a third hydropower system.

The first hydropower system includes:

a first inlet channel having a first inlet and a first outlet, where the first inlet channel extends from the first inlet towards the first outlet at a preset downward angle, the first inlet channel undergoes a 180-degree turn before connection to a first hydropower module for increasing the impact from seawater, and a number of first waterwheels are disposed at intervals between the first inlet and the first outlet along the first inlet channel;

a first hydropower module disposed underground for an appropriate depth including a second inlet, a second outlet and a hydropower unit, where the second inlet is connected to the first outlet; and

a number of first outlet channels, each including a first descending section, at least a first ascending section, at least a second descending section, at least a second ascending section and a third ascending section, where the first descending section has an end connected to the second outlet and another end connected to the first ascending section, there are same number of second descending sections and second ascending sections and they are end-to-end connected into an upward extending step-like structure, each second descending section descends for a vertical distance smaller than a vertical distance that a connected second ascending section ascends, a last second ascending section has an end connected to the third ascending section which has an outlet for discharging seawater, each of the first ascending sections, the second ascending sections, and the third ascending section is configured with a hoist device, each first waterwheel engages a hoist device through a driving shaft, each hoist device is also connected to a motor, the motors are electrically connected to the hydropower unit, 40% of the power produced by the hydropower unit is used to drive the motors, each first waterwheel, under the impact of seawater, drives a corresponding hoist device through the driving shaft, each hoist device is also driven by a corresponding motor, each motor's rotational speed is adjusted to be compatible with that of a corresponding first waterwheel, each hoist device is as such sufficiently powered to discharge seawater.

The second hydropower system includes:

a first inlet channel having a first inlet and a first outlet, where the first inlet channel extends from the first inlet towards the first outlet at a preset downward angle, and a number of first waterwheels are disposed at intervals between the first inlet and the first outlet along the first inlet channel;

a second hydropower module electrically connected to the first hydropower module including a second inlet, a second outlet, and a hydropower unit, where the second inlet is connected to the first outlet; and

a number of second outlet channels, each including a first descending section, at least a first ascending section, at least a second descending section, at least a second ascending section and a third ascending section, where the first descending section has an end connected to the second outlet and another end connected to the first ascending section, there are same number of second descending section and second ascending section and they are end-to-end connected into an upward extending step-like structure, each second descending section descends for a vertical distance smaller than a vertical distance that a connected second ascending section ascends, a last second ascending section has an end connected to the third ascending section which has an outlet for discharging seawater, each of the first ascending sections, the second ascending sections, and the third ascending section is configured with a hoist device, each first waterwheel engages a hoist device through a driving shaft, each hoist device is also connected to a motor, the motors are electrically connected to the hydropower unit, 30% of the power produced by the hydropower unit is used to drive the motors of the first hydropower system, each first waterwheel, under the impact of seawater, drives a corresponding hoist device through the driving shaft, each hoist device is also driven by a corresponding motor, each motor's rotational speed is adjusted to be compatible with that of a corresponding first waterwheel, each hoist device is as such sufficiently powered to discharge seawater.

The third hydropower system includes:

a first inlet channel having a first inlet and a first outlet, where the first inlet channel extends from the first inlet towards the first outlet at a preset downward angle, and a number of first waterwheels are disposed at intervals between the first inlet and the first outlet along the first inlet channel;

a third hydropower module electrically connected to the first hydropower module including a second inlet, a second outlet, and a hydropower unit, where the second inlet is connected to the first outlet; and

a number of third outlet channels, each including a first descending section, at least a first ascending section, at least a second descending section, at least a second ascending section and a third ascending section, where the first descending section has an end connected to the second outlet and another end connected to the first ascending section, there are same number of second descending section and second ascending section and they are end-to-end connected into an upward extending step-like structure, each second descending section descends for a vertical distance smaller than a vertical distance that a connected second ascending section ascends, a last second ascending section has an end connected to the third ascending section which has an outlet for discharging seawater, each of the first ascending sections, the second ascending sections, and the third ascending section is configured with a hoist device, each first waterwheel engages a hoist device through a driving shaft, each hoist device is also connected to a motor, the motors are electrically connected to the hydropower unit, 30% of the power produced by the hydropower unit is used to drive the motors of the first hydropower system, each first waterwheel, under the impact of seawater, drives a corresponding hoist device through the driving shaft, each hoist device is also driven by a corresponding motor, each motor's rotational speed is adjusted to be compatible with that of a corresponding first waterwheel, each hoist device is as such sufficiently powered to discharge seawater.

an underground facility accommodating the first hydropower system, the second hydropower system, and the third hydropower system.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the operation principle behind the present invention.

FIG. 2 is a schematic diagram showing a hydropower system according an embodiment of the present invention.

FIG. 3 is a functional block diagram showing the hydropower system of FIG. 2.

FIG. 4 is a schematic diagram showing multiple hydropower systems in parallel operation according an embodiment of the present invention.

FIG. 5 is a schematic top-view diagram showing the hydropower system of FIG. 2.

FIG. 6 is a schematic top-view diagram showing a hydropower system according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

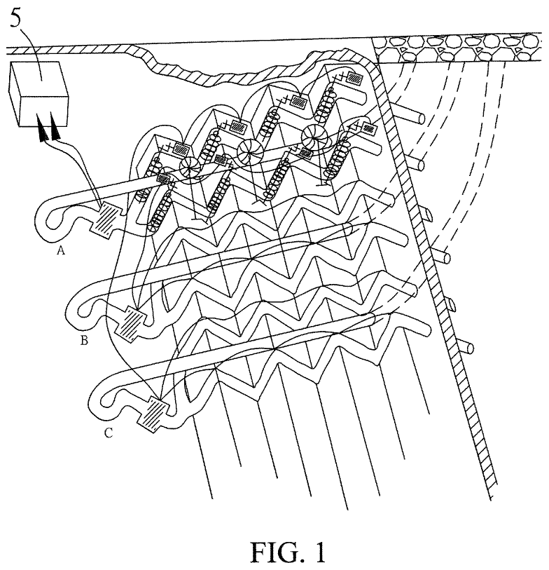

The operation principle behind the present invention is demonstrated in FIG. 1 and explained as follows.

Firstly, the systems of the present invention are installed besides embankments along a sea shore. The systems have seawater inlets beneath seawater level so that seawater may be continuously drawn into an underground power plant through inlet channels at a downward angle. As seawater enters the power plant, waterwheels and gears are engaged to drive upward delivering hoist devices. Depending on the power of the power generators involved, the number of waterwheels and the length of inlet channels may be determined. By the hoist devices, the seawater is lifted upward to ground level.

In conformation to the law of the conservation of energy, in an embodiment of the present invention, three systems A, B, C of a same power are installed and operated simultaneously. In order to lift seawater up to ground level, each hoist device is further configured with a motor, and the motors of system A is driven by a portion of the power produced by systems B and C.

Assuming that, to raise seawater to ground level, each system A, B, or C, if operated independently, require 100% of power. For each system, it would acquire 40% of the required power from the push by the seawater flowing in the inlet channel, and another 40% from the hoist devices driven by the waterwheels. System A then further obtains 35% of the power produced by each of systems B and C, respectively, to drive its motors. Then, system A would theoretically obtain a total power of 40%+40%+70%=150%.

As to systems B and C, each of them also acquires 40% of the required power from the push by the seawater flowing in the inlet channel, and another 40% from the hoist devices driven by the waterwheels. As both systems B and C would lose 35% of their generated power to system A, both systems would theoretically obtain a total power of 65%+40%+40%=145%. If the energy conversion efficiency is 70%, system A would obtain 105%, and both systems B and C would be 101.5%, respectively. Therefore, all three systems are able to raise seawater to ground level.

To prevent foreign objects from entering the inlet channels of the systems, water gates are provided at the inlets to control the amount of seawater drawn and to seal the inlets.

The above embodiment involves three systems of identical power to extract full hydropower from one of the systems. If the described configuration cannot extract the full hydropower of a system, additional systems such as systems B, C, D, E may be installed.

An alternative approach to use inlet channels of greater diameters to draw more seawater to create more power from systems B and C or more powerful motors are applied to raised seawater to ground level.

The additional benefits of the present invention include:
1. The present invention may be modularized and widely installed so that even countries without resources may also be energy export countries.
2. The seawater after being utilized for power generation and raised to ground level may be further used for sea farming, desalination, playground.

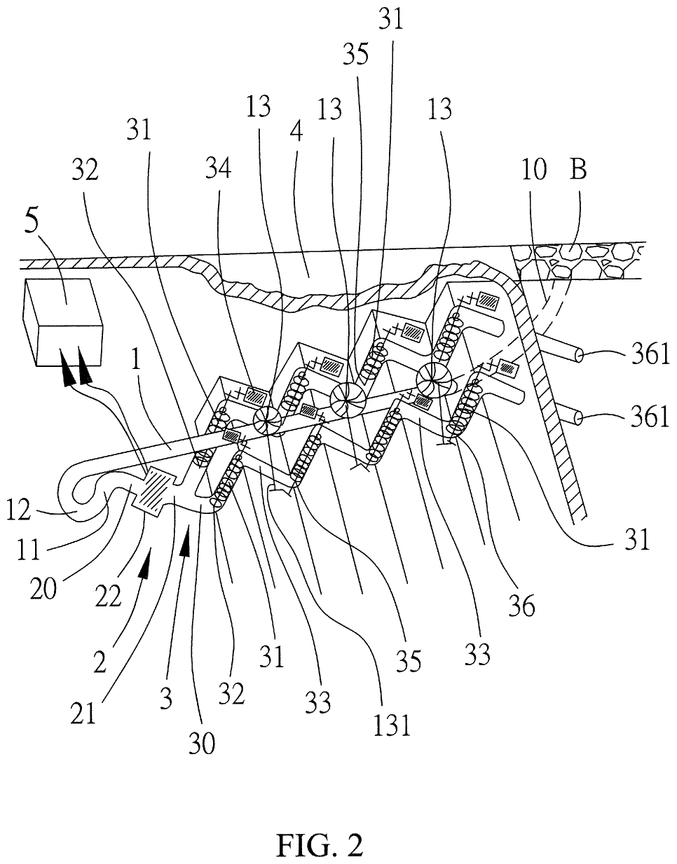

As shown in FIG. 2, a first hydropower system according to an embodiment of the present invention includes:

a first inlet channel 1 having a first inlet 10 and a first outlet 11, where the first inlet channel 1 extends from the first inlet 10 towards the first outlet 11 at a preset downward angle, the first inlet channel 1 undergoes a 180-degree turn 12 before connection to a first hydropower module 2 for increasing the impact from seawater, and a number of first waterwheels 13 are disposed at intervals between the first inlet 10 and the first outlet 11 along the first inlet channel 1;

a first hydropower module 2 disposed underground for an appropriate depth including a second inlet 20, a second outlet 21 and a hydropower unit 22, where the second inlet 20 is connected to the first outlet 11; and

a number of first outlet channels 3, each including a first descending section 30, at least a first ascending section 32, at least a second descending section 33, at least a second ascending section 35 and a third ascending section 36, where the first descending section 30 has an end connected to the second outlet 21 and another end connected to the first ascending section 32, there are same number of second descending sections 33 and second ascending sections 35 and they are end-to-end connected into an upward extending step-like structure, each second descending section 33 descends for a vertical distance smaller than a vertical distance that a connected second ascending section 35 ascends, a last second ascending section 35 has an end connected to the third ascending section 36 which has an outlet 361 for discharging seawater, each of the first ascending sections 32, the second ascending sections 35, and the third ascending section 36 is configured with a hoist device 31, each first waterwheel 13 engages a hoist device 31 through a driving shaft 131, each hoist device 31 is also connected to a motor 34, the motors 34 are electrically connected to the hydropower unit 22, 40% of the power produced by the hydropower unit 22 is used to drive the motors 34, each first waterwheel 13, under the impact of seawater, drives a corresponding hoist device 31 through the driving shaft 131, each hoist device 31 is also driven by a corresponding motor 34, each motor 34's rotational speed is adjusted to be compatible with that of a corresponding first waterwheel 13, each hoist device 31 is as such sufficiently powered to discharge seawater;

where, in the present embodiment, there are three second descending sections 33 and three second ascending section 35 and, therefore, three first waterwheels 13. The present invention is not limited as such. There may be more hoist devices 31 depending on how deep the present invention is positioned. There also may be more first outlet channels 3 depending on the amount of water discharged. A first descending section 30 may also be connected to multiple first ascending sections 32, and then to multiple waterwheels and hoist devices to increase the amount of discharged seawater;

an underground facility 4 accommodating the first inlet channel 1, the first hydropower module 2, and first outlet channels 3, where the facility 4 is installed behind embankment B along a sea shore, and the first hydropower module 2 is electrically connected to a public grid device 5 such as a substation so as to provide electricity to the public grid.

The first waterwheels 13 are pushed by seawater, which in turn engage hoist devices 31 through the driving shafts 131. Each hoist device 31 involves a screw to lift and carry seawater upward.

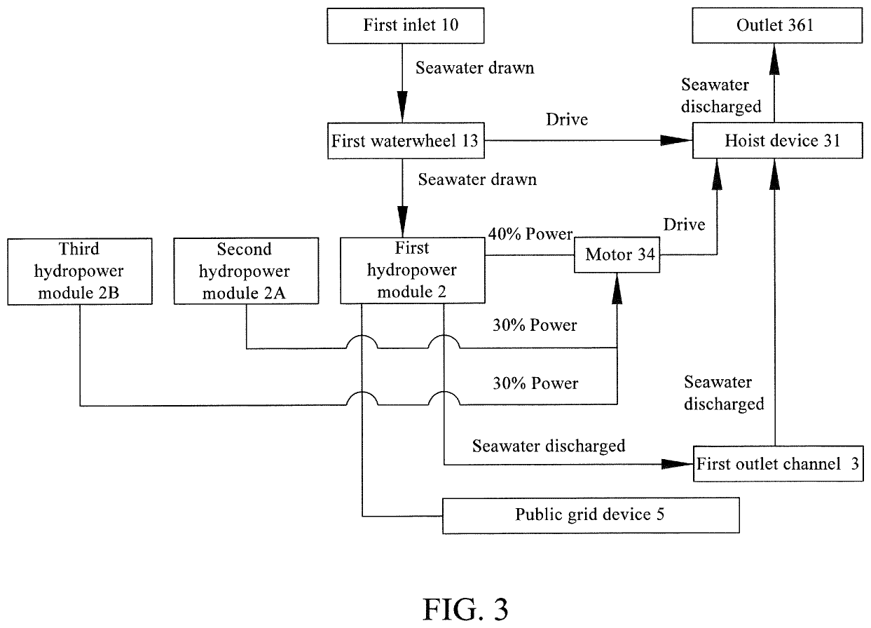

FIG. 3 demonstrates the structure and flow of the present invention. The first inlet 10 is provided above sea level so that seawater may naturally flow into the first inlet channel 1. The sea water in the first inlet channel 1 impacts each first waterwheel 13 to drive each hoist device 31 through the driving shaft 131. The seawater in the first inlet channel 1 then flows to the hydropower unit 22 for power generation, where 40% of the generated power is used to drive the motors 34 which in turn engage the hoist devices 31 to discharge seawater.

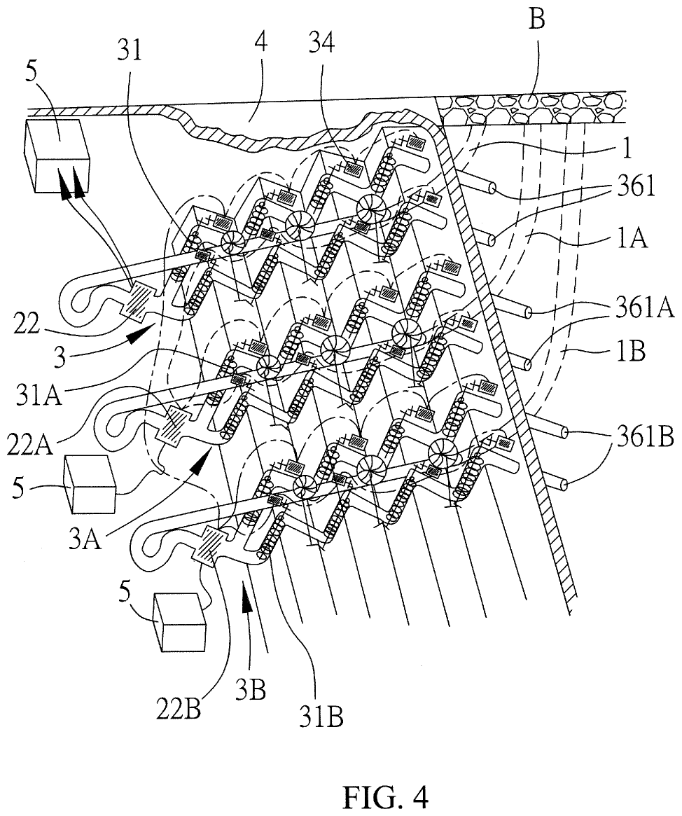

Multiple hydropower systems of the present invention may be operated in parallel to support each other. As shown in FIGS. 3 and 4, the present embodiment includes, in addition to the first hydropower system, a second hydropower system and a third hydropower system.

In the present embodiment, 40% of the power produced by the first hydropower module 2 of the first hydropower system is used to drive the hoist devices 31.

The second hydropower system includes:

a first inlet channel 1A having a first inlet and a first outlet, where the first inlet channel 1 A extends from the first inlet towards the first outlet at a preset downward angle, and a number of first waterwheels are disposed at intervals between the first inlet and the first outlet along the first inlet channel 1A;

a second hydropower module 2A electrically connected to the first hydropower module 2 including a second inlet, a second outlet, and a hydropower unit 22A, where the second inlet is connected to the first outlet; and

a number of second outlet channels 3A, each including a first descending section 30, at least a first ascending section 32, at least a second descending section 33, at least a second ascending section 35 and a third ascending section 36, where the first descending section 30 has an end connected to the second outlet 21 and another end connected to the first ascending section 32, there are same number of second descending section 33 and second ascending section 35 and they are end-to-end connected into an upward extending step-like structure, each second descending section 33 descends for a vertical distance smaller than a vertical distance that a connected second ascending section 35 ascends, a last second ascending section 35 has an end connected to the third ascending section 36 which has an outlet 361 for discharging seawater, each of the first ascending sections 32, the second ascending sections 35, and the third ascending section 36 is configured with a hoist device 31A, each first waterwheel 13 engages a hoist device 31A through a driving shaft 131, each hoist device 31 is also connected to a motor 34, the motors 34 are electrically connected to the hydropower unit 22A, 30% of the power produced by the hydropower unit 22A is used to drive the motors 34 of the first hydropower system, each first waterwheel 13, under the impact of seawater, drives a corresponding hoist device 31A through the driving shaft 131, each hoist device 31A is also driven by a corresponding motor 34, each motor 34's rotational speed is adjusted to be compatible with that of a corresponding first waterwheel 13, each hoist device 31A is as such sufficiently powered to discharge seawater.

The third hydropower system includes:

a first inlet channel having a first inlet and a first outlet, where the first inlet channel extends from the first inlet towards the first outlet at a preset downward angle, and a number of first waterwheels are disposed at intervals between the first inlet and the first outlet along the first inlet channel;

a third hydropower module 2B electrically connected to the first hydropower module 2 including a second inlet, a second outlet, and a hydropower unit 22B, where the second inlet is connected to the first outlet; and

a number of third outlet channels 3B, each including a first descending section, at least a first ascending section, at least a second descending section, at least a second ascending section and a third ascending section, where the first descending section has an end connected to the second outlet and another end connected to the first ascending section, there are same number of second descending section and second ascending section and they are end-to-end connected into an upward extending step-like structure, each second descending section descends for a vertical distance smaller than a vertical distance that a connected second ascending section ascends, a last second ascending section has an end connected to the third ascending section which has an outlet for discharging seawater, each of the first ascending sections 32, the second ascending sections 35, and the third ascending section 36 is configured with a hoist device 31B, each first waterwheel 13 engages a hoist device 31B through a driving shaft 131, each hoist device 31B is also connected to a motor 34, the motors 34 are electrically connected to the hydropower unit 22B, 30% of the power produced by the hydropower unit 22B is used to drive the motors 34 of the first hydropower system, each first waterwheel 13, under the impact of seawater, drives a corresponding hoist device 31B through the driving shaft 131, each hoist device 31B is also driven by a corresponding motor 34, each motor 34's rotational speed is adjusted to be compatible with that of a corresponding first waterwheel 13, each hoist device 31B is as such sufficiently powered to discharge seawater.

30% of the power produced respectively from the hydropower units 22A and 22B, together with 40% of the power produced from the power unit 22, are used to drive the motors 34 with full 100% power so that the motors 34 have enough power to discharge seawater.

The first hydropower system, second hydropower system, and third hydropower system mutually support each other to drive their respective hoist devices 31 to discharge seawater. As shown in FIG. 4, the hydropower unit 22A is electrically connected to motors 34 to drive hoist devices 31 for seawater discharging. The remaining power then may be directed to the public grid device 5.

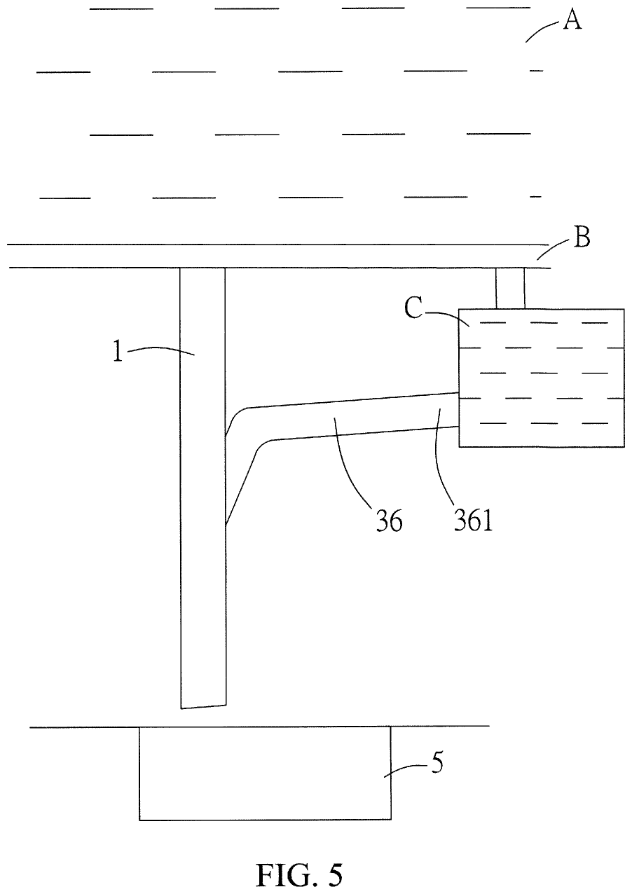

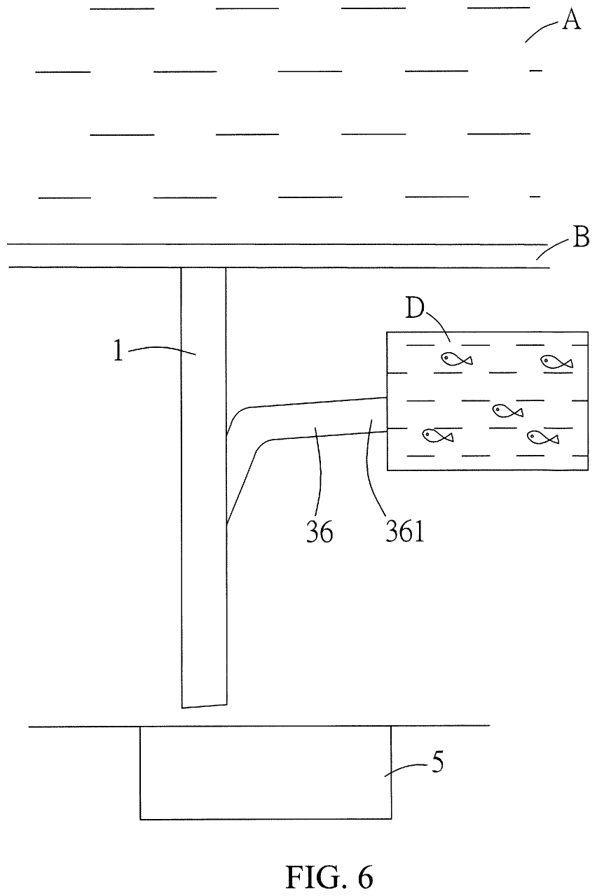

The first inlet 10 is provided beneath sea level of ocean A so that seawater may be naturally drawn without external force or a reservoir like a conventional dam. The first inlet channel 1 may be configured with filter screens (not shown) or water gate (not shown). The third ascending section 36, as shown in FIG. 5, may be directed toward a direction different from that of the first inlet channel 1 to avoid conflict. As shown of FIG. 6, in another embodiment of the present invention, the outlet 361 of the third ascending section 36 is connected to a seawater farming facility D for enhanced economic benefit. The outlet 361 may be provided beneath sea level so that the height difference between the first inlet 10 and the outlet 361 may be further utilized for power generation.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. Mutually supporting hydropower systems, comprising a first hydropower system, a second hydropower system, a third hydropower system, and a facility, wherein
the first hydropower system comprises
a first inlet channel having a first inlet and a first outlet, where the first inlet channel extends from the first inlet towards the first outlet at a preset downward angle;
a plurality of first waterwheels are disposed at intervals between the first inlet and the first outlet along the first inlet channel;
a first hydropower module disposed underground for an appropriate depth comprising a second inlet, a second outlet and a hydropower unit, where the second inlet is connected to the first outlet; and
a plurality of first outlet channels, each comprising a first descending section, a plurality of first ascending section, a plurality of second descending sections, a plurality of second ascending sections, and a third ascending section, where the first descending section has an end connected to the second outlet and another end connected to the first ascending sections, a same number of second descending sections and second ascending sections are end-to-end connected into an upward extending step-like structure between a first ascending section and a third ascending section, a last second ascending section has an end connected to the third ascending section which has an outlet for discharging seawater, each of the first ascending sections, the second ascending sections, and the third ascending section is configured with a hoist device, each first waterwheel engages a hoist device through a driving shaft, each hoist device is also connected to a motor, the motors are electrically connected to the hydropower unit, 40% of the power produced by the hydropower unit is used to drive the motors, each first waterwheel, under the impact of seawater, drives a corresponding hoist device through the driving shaft, each hoist device is also driven by a corresponding motor, each hoist device is as such sufficiently powered to discharge seawater;
the second hydropower system comprises
a first inlet channel having a first inlet and a first outlet, where the first inlet channel extends from the first inlet towards the first outlet at a preset downward angle;
a plurality of first waterwheels are disposed at intervals between the first inlet and the first outlet along the first inlet channel;
a second hydropower module electrically connected to the first hydropower module comprising a second inlet, a second outlet, and a hydropower unit, where the second inlet is connected to the first outlet; and
a plurality of second outlet channels, each comprising a first descending section, a plurality of first ascending sections, a plurality of second descending sections, a plurality of second ascending sections, and a third ascending section, where the first descending section has an end connected to the second outlet and another end connected to the first ascending sections, a same number of second descending sections and second ascending sections are end-to-end connected into an upward extending step-like structure between a first ascending section and a third ascending section, a last second ascending section has an end connected to the third ascending section which has an outlet for discharging seawater, each of the first ascending sections, the second ascending sections, and the third ascending section is configured with a hoist device, each first waterwheel engages a hoist device through a driving shaft, each hoist device is also connected to a motor, the motors are electrically connected to the hydropower unit, 30% of the power produced by the hydropower unit is used to drive the motors of the first hydropower system, each first waterwheel, under the impact of seawater, drives a corresponding hoist device through the driving shaft, each hoist device is also driven by a corresponding motor, each hoist device is as such sufficiently powered to discharge seawater;
the third hydropower system comprises
a first inlet channel having a first inlet and a first outlet, where the first inlet channel extends from the first inlet towards the first outlet at a preset downward angle;
a plurality of first waterwheels are disposed at intervals between the first inlet and the first outlet along the first inlet channel;
a third hydropower module electrically connected to the first hydropower module comprising a second inlet, a second outlet, and a hydropower unit, where the second inlet is connected to the first outlet; and
a plurality of third outlet channels, each comprising a first descending section, a plurality of first ascending sections, a plurality of second descending sections, a plurality of second ascending sections, and a third ascending section, where the first descending section has an end connected to the second outlet and another end connected to the first ascending sections, a same number of second descending sections and second ascending sections are end-to-end connected into an upward extending step-like structure between a first ascending section and the third ascending section, a last second ascending section has an end connected to the third ascending section which has an outlet for discharging seawater, each of the first ascending sections, the second ascending sections, and the third ascending section is configured with a hoist device, each first waterwheel engages a hoist device through a driving shaft, each hoist device is also connected to a motor, the motors are electrically connected to the hydropower unit, 30% of the power produced by the hydropower unit is used to drive the motors of the first hydropower system, each first waterwheel, under the impact of seawater, drives a corresponding hoist device through the driving shaft, each hoist device is also driven by a corresponding motor, each hoist device is as such sufficiently powered to discharge seawater; and
the facility is disposed underground accommodating the first hydropower system, the second hydropower system, and the third hydropower system.

2. The mutually supporting hydropower systems according to claim 1, wherein the first hydropower system, the second hydropower system, and the third hydropower system have their first inlets beneath sea level.

3. The mutually supporting hydropower systems according to claim 1, wherein the first hydropower system, the second hydropower system, and the third hydropower system have their respective first inlet channels turned, before respectively connecting to the first hydropower module, the second hydropower module, and the third hydropower module so that their respective first outlets extends toward sea level.

4. The mutually supporting hydropower systems according to claim 1, wherein the first hydropower system, the second hydropower system, and the third hydropower system are configured with filter screens.

5. The mutually supporting hydropower systems according to claim 1, wherein the first hydropower system, the second hydropower system, and the third hydropower system are configured with water gates.

6. The mutually supporting hydropower systems according to claim 1, wherein the first hydropower system, the second hydropower system, and the third hydropower system have their outlets connected to a seawater farming facility.

7. The mutually supporting hydropower systems according to claim 1, wherein each of the second descending sections descends for a vertical distance smaller than a vertical distance that a connected second ascending section ascends.
